(19) United States
(12) Patent Application Publication
(10) Pub. No.: US 2023/0404328 A1
(43) Pub. Date: Dec. 21, 2023

(54) COOKING APPARATUS

(71) Applicant: ICHIRAN INC., Fukuoka (JP)

(72) Inventor: Ryusuke SOBUE, Fukuoka (JP)

(21) Appl. No.: 18/251,605

(22) PCT Filed: Nov. 13, 2020
(86) PCT No.: PCT/JP2020/042531

§ 371 Date: May 3, 2023

(51) Int. Cl. A47J 44/00; A47J 27/18; A47J 47/01; A47J 36/32; B65G 43/10; G06Q 30/0601; G06Q 50/12

(52) U.S. Cl. CPC A47J 44/00; A47J 27/18; A47J 47/01; A47J 36/32; B65G 43/10; G06Q 30/0641; G06Q 50/12; A47J 2027/006

(57) ABSTRACT

A cooking apparatus (1) according to the present invention includes an acquisition component (341), a condition determination component (343), a supply unit (20), and an operation control component (344). The supply unit includes acquisition paths (211, 221, 231) that acquire the seasoning liquids from reserve tanks (T1 to T3), return paths (212, 222, 232) that return the seasoning liquids from the acquisition paths to the reserve tanks, supply paths (213, 223, 233) that supply the seasoning liquids from the acquisition paths to the container, and connection switch units (214, 224, 234) that switch connection among the paths by being controlled by the operation control component. The operation control component connects the acquisition paths to the supply paths when the seasoning liquids are supplied to the container, and connects the acquisition paths to the return paths when the seasoning liquids are not supplied to the container.

### TECHNICAL FIELD

The present invention relates to a cooking apparatus.

### BACKGROUND ART

In recent years, as the eating out industry has developed, the number of eating and drinking establishments has increased, and opening hours of the eating and drinking establishments have also tended to be extended. As a result, in the eating out industry, the number of employees required to prepare and serve food and drink products has been increasing. However, in the recent aging society, the employable population has been decreasing from year to year, and securing employees in each eating and drinking establishment has become more difficult from year to year.

Under such social circumstances, in the eating out industry, mechanization (manpower saving) of, for example, cooking and serving has been studied in order to reduce the number of employees required for eating and drinking establishments. Such mechanization is in progress in eating and drinking establishments having high financial power such as family restaurant chains with many locations. However, eating and drinking establishments having relatively low financial power can afford to use only small amounts of development funds and development time, and are lagging in mechanization.

Among them, eating and drinking establishments that serve what are called soup dishes such as ramen (Chinese-style Japanese noodle soup), udon (Japanese wheat noodle soup), soba (Japanese buckwheat noodle soup), nabemono (Japanese hot pot dishes), and soup cuisine handle soup (seasoning liquid) that is hot and is salty and oily. To mechanically supply such soup to a serving ware, stabilization of the quality (such as temperature, concentration, and liquid volume) of the soup, and anti-corrosion measures and sanitary management of a supply path are required. Such soup has characteristics (such as secrets and uncompromising standards) for each eating and drinking establishment and tastes differently for each eating and drinking establishment. In this manner, many problems are present in mechanizing the serving of soup dishes.

So far, techniques related to the mechanization of the serving of soup dishes have been proposed (for example, see PTL 1).

In the technique disclosed in PTL 1, a cylinder for soup adjustment is connected to a tank that reserves undiluted soup and a tank that reserves hot water at a predetermined temperature, through each supply pipe for the undiluted soup and the hot water. In the technique, when a piston of the cylinder returns to an original position, the undiluted soup and the hot water are supplied into the cylinder through the supply pipes and are prepared. When the piston is pushed in, the prepared soup is supplied to a container (such as a serving ware or a bowl) through a discharge pipe from the cylinder. The supply amount of each of the undiluted soup and the hot water is adjusted by a throttle valve connected to each supply pipe. A heat-retaining heater is attached to the cylinder, and the soup prepared in the cylinder is kept warm.

In the technique disclosed in PTL 1, the soup at a predetermined liquid volume, concentration, and temperature can be prepared in the cylinder. However, with the technique, residual liquids in the pipes cannot be discharged. Therefore, if the supply of the soup to the serving ware is stopped for a relatively long time, the temperature of the residual liquids in the pipes drops, and in addition, damage (degradation in quality) of the residual liquids can occur. Moreover, if a residual liquid is present in the discharge pipe from the cylinder, the amount and temperature of the soup supplied to the container are not stable, and a variation is likely to occur in the quality of the soup supplied to the container.

### CITATION LIST

### Patent Literature

[PTL 1] JP 2011-254726 A

### SUMMARY OF INVENTION

### Technical Problem

An object of the present invention is to provide a cooking apparatus capable of supplying a seasoning liquid having stable quality.

### Solution to Problem

A cooking apparatus according to the present invention is a cooking apparatus to supply a seasoning liquid to be included in a food and drink product to a container, and includes an acquisition component configured to acquire order information indicating a content of each order for the food and drink product, a condition determination component configured to determine a supply condition of the seasoning liquid, based on the order information, a supply unit configured to supply a predetermined liquid volume of the seasoning liquid to the container, based on the supply condition, and an operation control component configured to control operation of the supply unit. The supply unit includes an acquisition path configured to acquire the seasoning liquid from a reserve tank that reserves the seasoning liquid, a return path configured to return the seasoning liquid from the acquisition path to the reserve tank, a supply path configured to supply the seasoning liquid from the acquisition path to the container, and a connection switch unit configured to switch connection among the acquisition path, the return path, and the supply path by being controlled by the operation control component. The acquisition path is connected to the supply path when the seasoning liquid is supplied to the container, and the acquisition path is connected to the return path when the seasoning liquid is not supplied to the container.

### Advantageous Effects of Invention

According to the present invention, a seasoning liquid having stable quality can be supplied.

### BRIEF DESCRIPTION OF DRAWINGS

FIG. 1 is a schematic configuration diagram illustrating an embodiment of a cooking apparatus according to the present invention.

FIG. 2 is a piping diagram of a supply unit included in the cooking apparatus in FIG. 1.

FIG. 3 is a schematic cross-sectional view of a pipe illustrating a state in which the pipe constituting the supply unit in FIG. 2 is attached to and detached from a supporting unit included in the cooking apparatus in FIG. 1.

FIG. 4 is a schematic perspective view of a liquid receiver included in the supply unit in FIG. 2.

FIG. 5 is a schematic top view of the liquid receiver in FIG. 4.

FIG. 6 is a functional block diagram of the cooking apparatus in FIG. 1.

FIG. 7 is an explanatory diagram illustrating, in chronological order, an example of an operation of an operation control component included in the cooking apparatus in FIG. 1.

FIG. 8 is a schematic configuration diagram illustrating another embodiment of the cooking apparatus according to the present invention.

FIG. 9 is a piping diagram of a supply unit included in the cooking apparatus in FIG. 8.

FIG. 10 is a functional block diagram of the cooking apparatus in FIG. 8.

FIG. 11 is an explanatory diagram illustrating, in chronological order, an example of an operation of an operation control component included in the cooking apparatus in FIG. 8.

### DESCRIPTION OF EMBODIMENTS

Embodiments of a cooking apparatus according to the present invention will be described by way of the embodiments and the drawings given below. In the drawings, the same members and elements are denoted by the same reference signs, and the description thereof will be omitted.

The present invention is made to mechanically supply a seasoning liquid to be included in a food and drink product from a reserve tank that reserves the seasoning liquid to a container.

The “food and drink product” is cuisine classified into so-called soup dishes of food (such as ramen (Chinese-style Japanese noodle soup), udon (Japanese wheat noodle soup), soba (Japanese buckwheat noodle soup), nabemono (Japanese hot pot dishes), and soup cuisine) in which an ingredient is dipped in the seasoning liquid. In the present invention, the food and drink product includes the seasoning liquid and the ingredient dipped in the seasoning liquid.

The “seasoning liquid” is a liquid (such as soup of ramen, dipping sauce or broth of udon, soba, or nabemono, or soup of soup cuisine) in which the ingredient is dipped.

The “ingredient” is a solid food (such as noodles of ramen, udon, soba, or vegetables of nabemono and soup cuisine) that is clipped in the seasoning liquid.

The “reserve tank” is a container (such as a stockpot, a cooking tray, a plastic container, a bowl, or a bucket) that reserves undiluted soup for the seasoning liquid or liquids (including water or hot water for diluting the undiluted soup) that are mixed to be the seasoning liquid.

The “container” is a serving ware (such as a bowl for ramen, udon, or soba, a pot for nabemono, or a soup plate for soup cuisine) in which the seasoning liquid is poured when the food and drink product is served to a guest (customer).

The embodiments of the present invention will be described below using ramen as an example of the food and drink product in the present invention. Soup of ramen includes undiluted soup and broth, and in addition, includes oil in some cases. That is, for example, in the following description, an example of the seasoning liquid in the present invention is the soup of ramen, and the undiluted soup, the broth, and the oil included in the soup. An example of the ingredient in the present invention is noodles of ramen, and an example of the container in the present invention is a bowl for ramen.

### Cooking Apparatus (1)

### Configuration of Cooking Apparatus (1)

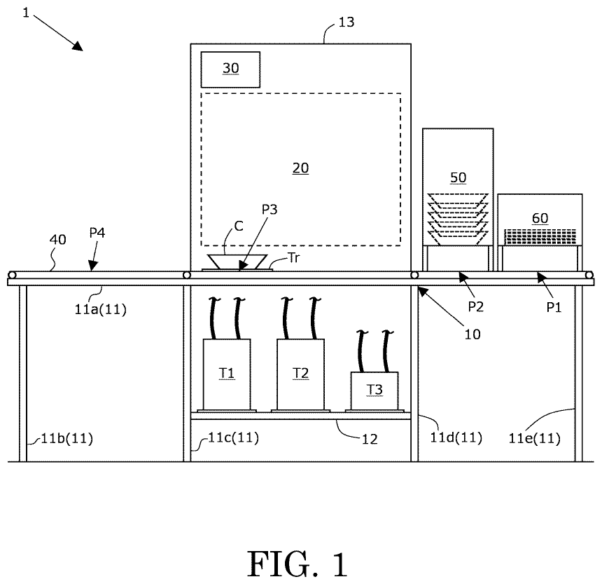

FIG. 1 is a schematic configuration diagram illustrating an embodiment of a cooking apparatus according to the present invention (hereinafter, referred to as a “present apparatus”).

A present apparatus 1 supplies a seasoning liquid (soup of ramen: undiluted soup, broth, and oil) included in a food and drink product (ramen) to a container C (bowl). The present apparatus 1 includes a housing 10, a supply unit 20, a control device 30, a conveying unit 40, a container accommodating unit 50, and a tray accommodating unit 60.

The housing 10 supports the supply unit 20, the control device 30, the conveying unit 40, the container accommodating unit 50, and the tray accommodating unit 60. The housing 10 includes a main body unit 11, a container supporting unit 12, and a pipe supporting unit 13.

The main body unit 11 is, for example, a desk or a table that mainly supports the conveying unit 40, the container accommodating unit 50, and the tray accommodating unit 60. The main body unit 11 is made of, for example, a metal such as stainless steel. The main body unit 11 includes a top panel 11a and a plurality of leg units lib to lie that support the top panel 11a.

The container supporting unit 12 is, for example, a shelf plate that supports reserve tanks (a first reserve tank T1, a second reserve tank T2, and a third reserve tank T3) each of which reserves each seasoning liquid. The container supporting unit 12 is made of, for example, a metal such as stainless steel. The container supporting unit 12 is disposed, for example, below the top panel 11a of the main body unit 11.

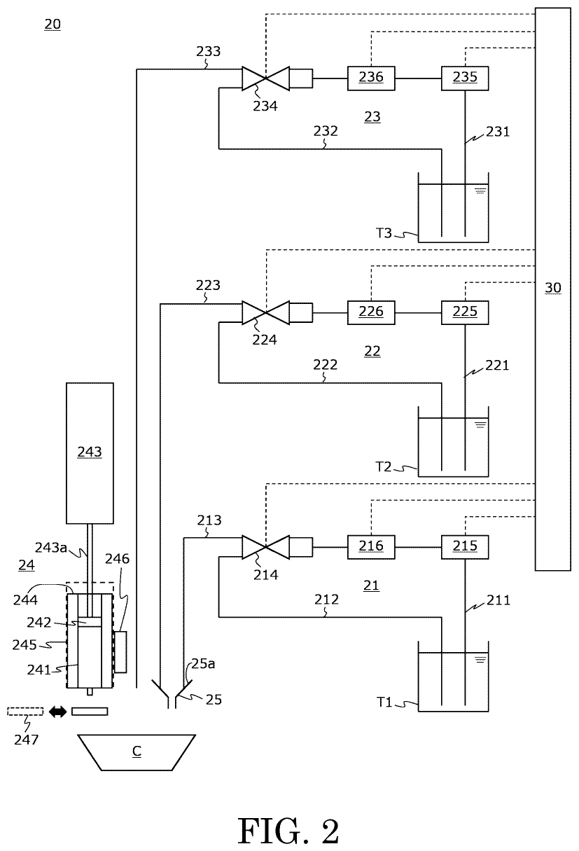

In the present embodiment, the first reserve tank T1 is a stockpot that reserves the undiluted soup; the second reserve tank T2 is a stockpot that reserves the broth that dilutes the undiluted soup; and the third reserve tank T3 is a pot that reserves the oil that is determined whether to be required based on an order. Each of the first reserve tank T1, the second reserve tank T2, and the third reserve tank T3 is placed on, for example, a heater (not illustrated), and is heated to a predetermined temperature and is kept warm. In the present embodiment, the undiluted soup and the broth are supplied in response to all orders, and the oil is supplied in response to some of the orders. That is, each of the undiluted soup and the broth is an example of a specific seasoning liquid in the present invention, and the oil is an example of a non-specific seasoning liquid in the present invention. For introduction of air into the supply unit 20 described below, each of the reserve tanks is disposed such that a liquid level of the reserved seasoning liquid (the undiluted soup, the broth, or the oil) is lower than an exit of the below-described air introduction path (supply path 213, 223, or 233; see FIG. 2).

Note that each of the reserve tanks need not be heated, or may be cooled, depending on the type of the reserved seasoning liquid.

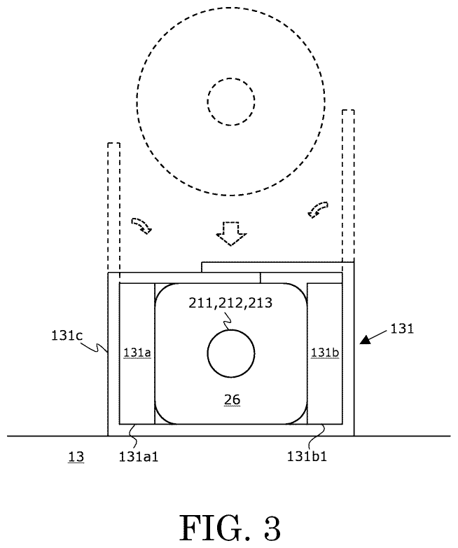

The pipe supporting unit 13 is a panel that mainly supports the supply unit 20 and the control device 30. The pipe supporting unit 13 is, for example, a standing board of a metal such as stainless steel. The pipe supporting unit 13 is provided so as to stand on the top panel 11a of the main body unit 11. The pipe supporting unit 13 includes a plurality of supporting units 131 described below (see FIG. 3).

FIG. 2 is a piping diagram of the supply unit 20.

For convenience of description, FIG. 2 also illustrates the control device 30 and wiring between the supply unit 20 and the control device 30. FIG. 2 also schematically illustrates a configuration of a below-described viscous body supply unit 24.

The supply unit 20 supplies a predetermined liquid volume of the seasoning liquid to the container C, based on a below-described supply condition. The supply unit 20 includes a first supply unit 21, a second supply unit 22, a third supply unit 23, the viscous body supply unit 24, and a liquid receiver 25.

The first supply unit 21 supplies the seasoning liquid (hereinafter, referred to as “undiluted soup”) reserved in the first reserve tank T1 to the container C. The first supply unit 21 includes an acquisition path 211, a return path 212, the supply path 213, a valve 214, a pump 215, and a flow meter 216. In the following description, the acquisition path 211, the return path 212, and the supply path 213 are collectively called “paths 211 to 213” when not distinguished from one another.

The acquisition path 211 is a path to acquire the undiluted soup from the first reserve tank T1. The acquisition path 211 is constituted of, for example, a pipe and a joint. An end on an upstream side of the acquisition path 211 is disposed in the undiluted soup in the first reserve tank T1. An end on a downstream side of the acquisition path 211 branches into two lines, which are connected to the valve 214.

The return path 212 is a path to return the undiluted soup from the acquisition path 211 to the first reserve tank T1. The return path 212 is constituted of, for example, a pipe and a joint. An end on an upstream side of the return path 212 is connected to the valve 214. An end on a downstream side of the return path 212 is disposed in the undiluted soup in the first reserve tank T1.

The supply path 213 is a path to supply the undiluted soup from the acquisition path 211 to the container C. The supply path 213 is constituted of, for example, a pipe and a joint. An end on an upstream side of the supply path 213 is connected to the valve 214. An end on a downstream side (exit) of the supply path 213 is connected to an inner surface 25a of the liquid receiver 25. The connection between the end on the downstream side of the supply path 213 and the inner surface 25a of the liquid receiver 25 will be described below.

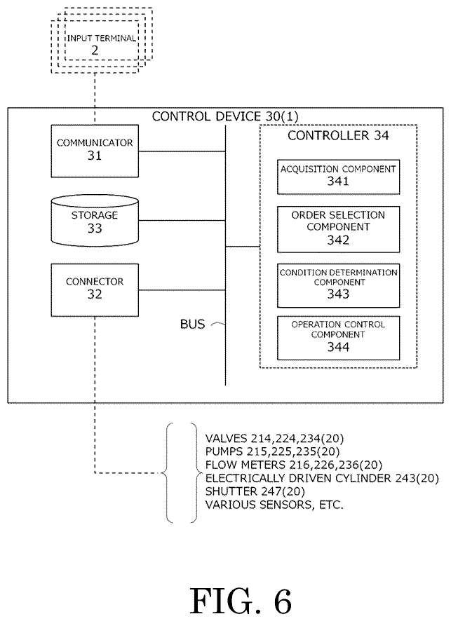

The valve 214 switches the connection of the acquisition path 211 to the return path 212 or to the supply path 213. That is, the valve 214 switches between the connection between the acquisition path 211 and the return path 212 and the connection between the acquisition path 211 and the supply path 213. The valve 214 is an example of a connection switch unit in the present invention. The valve 214 is, for example, a pinch valve. The operation of the valve 214 is electrically controlled by a below-described operation control component 344 (see FIG. 6; the same applies below).

The pump 215 is attached to the acquisition path 211, and discharges the undiluted soup to the acquisition path 211. The pump 215 is, for example, a tube pump.

The flow meter 216 is attached to the acquisition path 211, and measures a flow amount of the undiluted soup that flows in the acquisition path 211. The flow meter 216 is, for example, a clamp-on ultrasonic flow meter.

The second supply unit 22 supplies the broth reserved in the second reserve tank T2 to the container C. The second supply unit 22 includes an acquisition path 221, a return path 222, the supply path 223, a valve 224, a pump 225, and a flow meter 226. In the following description, the acquisition path 221, the return path 222, and the supply path 223 are collectively called “paths 221 to 223” when not distinguished from one another. The main configuration of the second supply unit 22 is common to the configuration of the first supply unit 21.

The acquisition path 221 is a path that acquires the broth from the second reserve tank T2. The acquisition path 221 is constituted of, for example, a pipe and a joint. An end on an upstream side of the acquisition path 221 is disposed in the broth in the second reserve tank T2. An end on a downstream side of the acquisition path 221 branches into two lines, which are connected to the valve 224.

The return path 222 is a path to return the broth from the acquisition path 221 to the second reserve tank T2. The return path 222 is constituted of, for example, a pipe and a joint. An end on an upstream side of the return path 222 is connected to the valve 224. An end on a downstream side of the return path 222 is disposed in the broth in the second reserve tank T2.

The supply path 223 is a path to supply the broth from the acquisition path 221 to the container C. The supply path 223 is constituted of, for example, a pipe and a joint. An end on an upstream side of the supply path 223 is connected to the valve 224. An end on a downstream side (exit) of the supply path 223 is connected to the inner surface 25a of the liquid receiver 25. The connection between the end on the downstream side of the supply path 223 and the inner surface 25a of the liquid receiver 25 will be described below.

The valve 224 switches the connection of the acquisition path 221 to the return path 222 or to the supply path 223. That is, the valve 224 switches between the connection between the acquisition path 221 and the return path 222 and the connection between the acquisition path 221 and the supply path 223. The valve 224 is an example of the connection switch unit in the present invention. The valve 224 is, for example, a pinch valve. The operation of the valve 224 is electrically controlled by the operation control component 344.

The pump 225 is attached to the acquisition path 221, and discharges the broth to the acquisition path 221. The pump 225 is, for example, a tube pump.

The flow meter 226 is attached to the acquisition path 221, and measures a flow amount of the broth that flows in the acquisition path 221. The flow meter 226 is, for example, a clamp-on ultrasonic flow meter.

The third supply unit 23 supplies the oil reserved in the third reserve tank T3 to the container C. The third supply unit 23 includes an acquisition path 231, a return path 232, the supply path 233, a valve 234, a pump 235, and a flow meter 236. In the following description, the acquisition path 231, the return path 232, and the supply path 233 are collectively called “paths 231 to 233” when not distinguished from one another. The main configuration of the third supply unit 23 is common to the configuration of the second supply unit 22.

The acquisition path 231 is a path that acquires the oil from the third reserve tank T3. The acquisition path 231 is constituted of, for example, a pipe and a joint. An end on an upstream side of the acquisition path 231 is disposed in the oil in the third reserve tank T3. An end on a downstream side of the acquisition path 231 branches into two lines, which are connected to the valve 234.

The return path 232 is a path to return the oil from the acquisition path 231 to the third reserve tank T3. The return path 232 is constituted of, for example, a pipe and a joint. An end on an upstream side of the return path 232 is connected to the valve 234. An end on a downstream side of the return path 232 is disposed in the oil in the third reserve tank T3.

The supply path 233 is a path to supply the oil from the acquisition path 231 to the container C. The supply path 233 is constituted of, for example, a pipe and a joint. An end on an upstream side of the supply path 233 is connected to the valve 234. An end on a downstream side (exit) of the supply path 233 is disposed above the container C (a below-described supply position P3).

Note that the exit of the supply path of the third supply unit may abut on the inner surface 25a of the liquid receiver 25 in the same manner as the exit of each of the first supply unit and the second supply unit.

The valve 234 switches the connection of the acquisition path 231 to the return path 232 or to the supply path 233. That is, the valve 234 switches the connection between the acquisition path 231 and the return path 232 and the connection between the acquisition path 231 and the supply path 233. The valve 234 is an example of the connection switch unit in the present invention. The valve 234 is, for example, a pinch valve. The operation of the valve 234 is electrically controlled by the operation control component 344.

The pump 235 is attached to the acquisition path 231, and discharges the oil to the acquisition path 231. The pump 235 is, for example, a tube pump.

The flow meter 236 is attached to the acquisition path 231, and measures a flow amount of the oil that flows in the acquisition path 231. The flow meter 236 is, for example, a clamp-on ultrasonic flow meter.

The first supply unit 21 and the second supply unit 22 are attached to one surface (first surface) of the pipe supporting unit 13 (see FIG. 1). The third supply unit 23 is attached to the other surface (second surface) of the pipe supporting unit 13. In this case, the pipes and the joints constituting the paths 211 to 213, 221 to 223, and 231 to 233 are attached to the pipe supporting unit 13 in such a way as to be detachable by a human hand.

FIG. 3 is a schematic cross-sectional view of the pipe illustrating, using the paths 211 to 213 as an example, a state in which the pipe constituting the paths 211 to 213 is attached to and detached from one of the supporting units 131 of the pipe supporting unit 13. FIG. 3 illustrates a state in which the pipe is detached from the supporting unit 131 with dashed lines.

As illustrated in FIG. 3, the supporting unit 131 includes two pinching members 131a and 131b and a bridge member 131c attached in a bridging manner between the pinching members 131a and 131b. The pinching members 131a and 131b have, for example, a rectangular plate shape and are made of a metal such as stainless steel. The pinching members 131a and 131b are disposed so as to face each other with a gap therebetween smaller than the outside diameter of a pipe thermal insulating material 26. The bridge member 131c is, for example, a known hook-and-loop fastener tape that is openable and closable. The bridge member 131c is guided through grooves 131a1 and 131b1 (or holes) on the pipe supporting unit 13 side of the pinching members 131a and 131b, and is attached in a closed state in a bridging manner between the two pinching members 131a and 131b. Each of the pipes is fitted in between the pinching members 131a and 131b by fitting in the pipe thermal insulating material 26 between the pinching members 131a and 131b in the state in which the bridge member 131c is opened (in the state indicated by dashed lines in FIG. 3). Then, the bridge member 131c is closed, and as a result, the pipe is fixed to the supporting unit 131. With this configuration, the pipe can be easily attached and detached between the pinching members 131a and 131b by only opening and closing the bridge member 131c. As a result, the maintainability of the pipes, joints, and valves constituting the supply unit 20 is improved.

Referring now back to FIG. 2 and FIG. 3, the pipes and the joints of the paths 211 to 213, 221 to 223, and 231 to 233 are each made of, for example, a synthetic resin such as a fluorinated resin. Each of the paths 211 to 213, 221 to 223, and 231 to 233 is covered with the pipe thermal insulating material 26 made of, for example, a synthetic resin such as polyethylene (PE).

Note that each of the pipes and the joints of the paths in the present embodiment may be made of stainless steel.

In the present embodiment, each of the valves 214, 224, and 234 has two flow channels (paths). That is, each of the valves 214, 224, and 234 is switchable between the two flow channels.

In the present embodiment, the valves 214, 224, and 234 are pinch valves; the pumps 215, 225, and 235 are tube pumps; and the flow meters 216, 226, 236 are clamp-on ultrasonic flow meters. Therefore, the seasoning liquids that flow through the paths 211 to 213, 221 to 223, and 231 to 233 do not contact other components than the pipes and the channels, and are sanitary.

Referring now back to FIG. 2, the viscous body supply unit 24 supplies a viscous body-like seasoning to the container C. The viscous body supply unit 24 includes a syringe 241, a pushing piece 242, an electrically driven cylinder 243, a holder 244, a case 245, a temperature adjusting unit 246, and a shutter 247.

The “viscous body-like seasoning” is a food more viscous than the seasoning liquid (soup). In the present embodiment, the seasoning is garlic that has been grated (grated garlic).

The syringe 241 is a syringe (barrel) that is filled with the grated garlic. The syringe 241 is made of, for example, a synthetic resin such as polypropylene (PP).

The pushing piece 242 is a distal end portion of a plunger that pushes out the grated garlic in the syringe 241. The pushing piece 242 is made of, for example, a synthetic resin such as polypropylene, and an O-ring is mounted on an outer peripheral surface of the pushing piece 242. In the present embodiment, the pushing piece 242 is a separate body from a below-described plunger rod 243a, and is handled together with the syringe 241. The syringe 241 filled with the grated garlic is fitted in the holder 244 in a state of being sealed by the pushing piece 242.

The electrically driven cylinder 243 includes the plunger rod 243a that advances and retreats with respect to the syringe 241, and advances and retreats the pushing piece 242 with respect to the syringe 241 by moving the plunger rod 243a. The electrically driven cylinder 243 is attached to the second surface of the pipe supporting unit 13.

The holder 244 holds the syringe 241 in such a way as to be detachable by a human hand. The holder 244 is made of, for example, a metal having high thermal conductivity such as aluminum. The holder 244 has a groove in which the syringe 241 is fitted, and has a U-shape in a top view. The holder 244 is disposed in the case 245. The holder 244 abuts on an inner surface of the case 245.

Note that the material of the holder in the present invention only needs to be a metal having high thermal conductivity (equal to or higher than, for example, 100 W·m⁻¹·k⁻¹ at 0° C.), and is not limited to aluminum.

The case 245 accommodates the syringe 241 and the holder 244. The case 245 is made of, for example, a metal such as stainless steel. The case 245 includes, for example, a door that is opened and closed when the syringe 241 is replaced, and has a hole (not illustrated) that opens toward below the syringe 241. The case 245 is disposed below the electrically driven cylinder 243, and is attached to the second surface of the pipe supporting unit 13.

The temperature adjusting unit 246 adjusts the temperature of the grated garlic filled in the syringe 241 to a predetermined temperature in the case 245. The temperature adjusting unit 246 is a heating/cooling medium using a Peltier device, for example. The temperature adjusting unit 246 abuts on an outer surface of the case 245. As a result, heat from the temperature adjusting unit 246 is transmitted to the syringe 241 through the case 245 and the holder 244.

Note that the temperature adjusting unit in the present invention may be disposed so as to abut on the holder through a hole formed in the case.

The shutter 247 restricts unnecessary supply of the grated garlic from the syringe 241. The shutter 247 has, for example, a plate shape and is made of a metal such as stainless steel. The shutter 247 is disposed below the hole of the case 245. The shutter 247 includes a driving unit (not illustrated), and is capable of advancing to and withdrawing from below the hole (syringe 241).

The liquid receiver 25 reduces flow velocities of the seasoning liquids (the undiluted soup and the broth) to be discharged from the exits of the respective supply paths 213 and 223. The liquid receiver 25 has a mortar-shaped (funnel-shaped) through-hole 25h passing through in the up-down direction and the mortar-shaped (funnel-shaped) inner surface 25a. The liquid receiver 25 is disposed below the exits of the respective supply paths 213 and 223, and is attached to the first surface of the pipe supporting unit 13. That is, the liquid receiver 25 is disposed between the exits of the supply paths 213 and 223 and the container C.

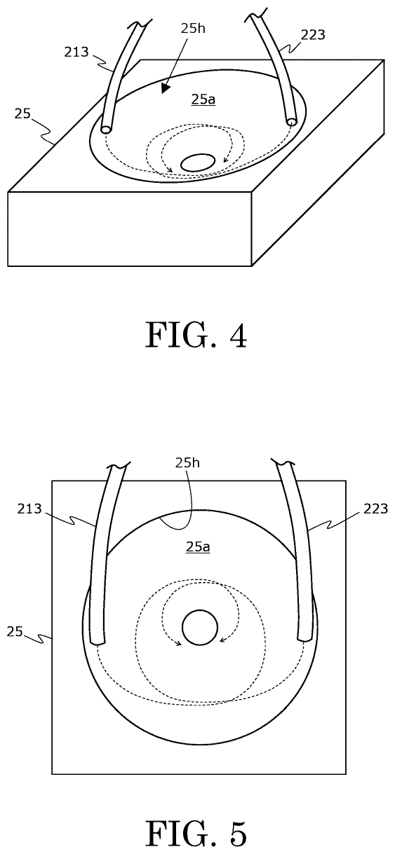

FIG. 4 is a schematic perspective view of the liquid receiver 25. FIG. 5 is a schematic top view of the liquid receiver 25. FIG. 4 and FIG. 5 also illustrate the exits of the supply paths 213 and 223. FIG. 4 and FIG. 5 also indicate flows of the seasoning liquids (the undiluted soup and the broth) to be discharged from the supply paths 213 and 223 with dashed line arrows.

The exits of the supply paths 213 and 223 abut on the inner surface of the liquid receiver 25 in a state of being directed obliquely downward. The exits are disposed along tangential directions of the inner surface 25a in the top view. As a result, the seasoning liquids discharged from the supply paths 213 and 223 spirally revolve along the inner surface 25a. In this case, the flow velocities of the seasoning liquids are reduced. The seasoning liquids are supplied from an opening at a lower portion of the liquid receiver to the container C (see FIG. 1) disposed below the liquid receiver 25.

FIG. 6 is a functional block diagram of the control device 30.

The control device 30 controls the overall operation of the present apparatus 1. The control device 30 includes a communicator 31, a connector 32, a storage 33, and a controller 34. The control device 30 is, for example, a personal computer (PC).

The communicator 31 communicates with an external device (for example, an input terminal 2 to be used by a guest who comes to an eating and drinking establishment) through a communication line (such as a wireless communication line). The communicator 31 is constituted of, for example, a communication module and an antenna (which are not illustrated).

The connector 32 is an interface connected to, for example, the valves 214, 224, and 234, the pumps 215, 225, and 235, the flow meters 216, 226, 236, the electrically driven cylinder 243, the driving unit of the shutter 247, and below-described sensors.

The storage 33 stores information required for the operation of the present apparatus 1. The storage 33 is constituted of, for example, a recording device such as a hard disk drive (HDD) or a solid-state drive (SSD) and/or a semiconductor memory device such as a random-access memory (RAM) or a flash memory.

The controller 34 controls the overall operation of the present apparatus 1. The controller 34 is constituted of, for example, a processor such as a central processing unit (CPU) or a digital signal processor (DSP) and a semiconductor memory such as a RAM or a read-only memory (ROM). The controller 34 includes an acquisition component 341, an order selection component 342, a condition determination component 343, and the operation control component 344.

The acquisition component 341 acquires information (such as order information, ingredient information, number-of-people information, and remaining amount information) required for the operation of the present apparatus 1. Details of the ingredient information, the number-of-people information, and the remaining amount information will be described below.

The “order” is, for example, an order of ramen transmitted from the input terminal 2 operated by a guest. The “order information” is information indicating a content of each order. The order information includes information on time when the order is fixed (time information) and information on details of the ramen desired by the guest (hereinafter, referred to as “order details information”). The order details information includes information on, for example, the type of soup, thickness of the soup, hardness of noodles, presence or absence of oil, and the type of topping.

When the acquisition component 341 acquires a plurality of pieces of the order information corresponding to a plurality of orders, the order selection component 342 selects, from among the plurality of pieces of order information, order information to be used by the condition determination component 343 to determine a supply condition.

The condition determination component 343 determines the supply condition of the seasoning liquids (soup), based on the order information.

The “supply condition” is a condition on the supply of the seasoning liquids, such as a blending ratio of the seasoning liquids (ratio between the undiluted soup and the broth), liquid volume of the seasoning liquids (total volume of the soup), presence or absence of oil and the liquid volume thereof, and presence or absence of grated garlic and the amount thereof.

The operation control component 344 controls the operation of the supply unit 20. The operation of the operation control component 344 will be described below.

Referring now back to FIG. 1, the conveying unit 40 conveys a tray Tr and the container C placed on the tray Tr. The conveying unit 40 is, for example, a belt conveyor. The conveying unit 40 is disposed on the top panel 11a of the main body unit 11. The conveying unit 40 conveys the tray Tr from a first receiving position P1 in which the tray Tr is received from the tray accommodating unit 60 to a second receiving position P2 in which the container C is received from the container accommodating unit 50. The second receiving position P2 is a receiving position in the present invention. Then, the conveying unit 40 conveys the tray Tr and the container C from the second receiving position P2 to the supply position P3 in which the seasoning liquids are supplied to the container C. Then, the conveying unit 40 conveys the tray Tr and the container C from the supply position P3 to a delivery position (position in which the ingredient is delivered into the container C supplied with the seasoning liquids) P4.

The container accommodating unit 50 accommodates a plurality of the containers C. The containers C are accommodated in a state of being stacked in the up-down direction in the container accommodating unit 50. The container accommodating unit 50 is disposed at the second receiving position P2 of the conveying unit 40. The container accommodating unit 50 includes, for example, a heater (not illustrated) that warms the containers C to a predetermined temperature and a known mechanism that discharges the containers C one by one to the second receiving position P2.

The tray accommodating unit 60 accommodates a plurality of the trays Tr. The trays Tr are accommodated in a state of being stacked in the up-down direction in the tray accommodating unit 60. The tray accommodating unit 60 is disposed at the first receiving position P1 of the conveying unit 40. The tray accommodating unit 60 includes, for example, a known mechanism that discharges the trays Tr one by one to the second receiving position P2.

### Operation of Cooking Apparatus (1)

The operation of the present apparatus 1 will now be described with reference to FIG. 1, FIG. 2, and FIG. 6.

First, the acquisition component 341 acquires order information from the input terminal 2 through the communicator 31. The order information is stored, for example, in the storage 33.

Then, the order selection component 342 selects the order information to be used by the condition determination component 343 to determine a supply condition, based on order details information included in the order information. The order selection component 342 selects the order information in the order of time specified by the time information as a general rule. Other methods of selection by the order selection component 342 will be described below.

Then, the condition determination component 343 determines the supply condition of soup, based on the order details information included in the order information.

Then, the conveying unit 40 conveys the tray Tr received at the first receiving position P1 to the second receiving position P2, and conveys the container C received onto the tray Tr at the second receiving position P2 to the supply position P3. In this case, the container C on the tray Tr moves along a guide (not illustrated) disposed on the near side of the supply position P3, and is positioned at substantially the center in the width direction of the conveying unit 40.

When the container C has been conveyed to the supply position P3, the operation control component 344 appropriately operates the pumps 215, 225, and 235, the valves 214, 224, and 234, the electrically driven cylinder 243, and the shutter 247 to supply a predetermined liquid volume of the soup (a predetermined liquid volume of the oil and a predetermined amount of the grated garlic according to the order) to the container C. Details of the operation of the operation control component 344 will be described below.

Then, the conveying unit 40 conveys the container C supplied with the soup to a deliver position P4.

### Operation of Operation Control Component (1)

The operation of the operation control component 344 will now be described below. In the present embodiment, operations of the first supply unit 21, the second supply unit 22, and the third supply unit 23 are common to one another. Therefore, the operation of the operation control component 344 will be described below using the operation of the first supply unit 21 as an example.

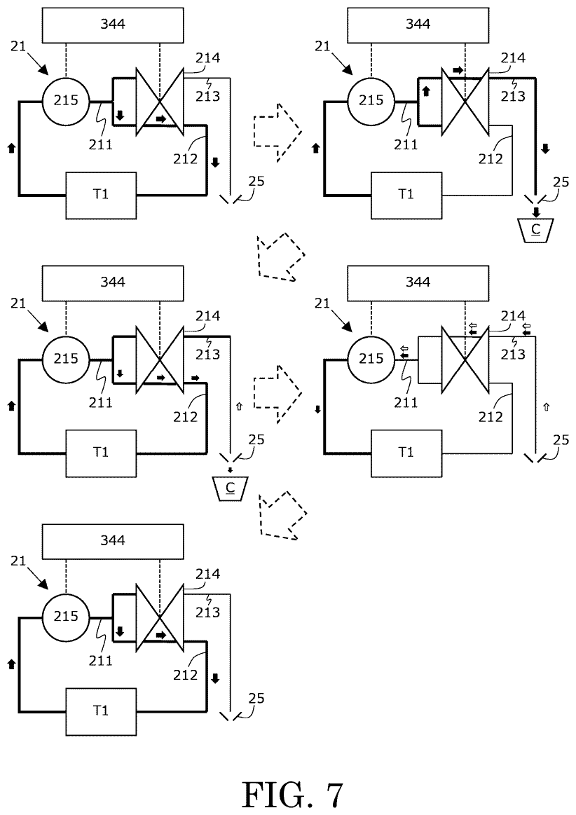

FIG. 7 is an explanatory diagram illustrating an example of the operation of the operation control component 344 in chronological order. FIG. 7 indicates the flow of the liquid (undiluted soup) with black arrows and a flow of air with white arrows.

First, when the undiluted soup (that is, the soup) is not supplied to the container C, the operation control component 344 controls the operation of the valve 214 so as to connect the acquisition path 211 to the return path 212. In this case, the operation control component 344 intermittently operates the pump 215 in a forward direction (in a direction in which the undiluted soup is discharged from the pump 215 toward the return path 212 and the supply path 213) at intervals of a predetermined time. As a result, the undiluted soup circulates from the first reserve tank T1 through the acquisition path 211 and the return path 212 to the first reserve tank T1. That is, the acquisition path 211 and the return path 212 constitute a path (circulation path) through which the undiluted soup circulates. The valve 214 functions as a loop valve in the present invention.

In this way, the undiluted soup circulates through the circulation path to generate convection in the undiluted soup in the first reserve tank T1, and the undiluted soup in the first reserve tank T1 is stirred. As a result, variations in concentration and temperature of the undiluted soup in the first reserve tank T1 are reduced, and the undiluted soup heated and kept warm at a relatively high temperature is also restrained from bumping in the first reserve tank T1. In addition, the undiluted soup at a constant concentration and at a predetermined temperature or higher always flows in the forward direction through the circulation path (in particular, the acquisition path 211). Moreover, since the pump 215 intermittently operates, power-saving can be achieved, and a tube that receives pressure by the tube pump is restrained from deteriorating.

Note that the operation control unit in the present invention may operate the pump such that, when the undiluted soup is not supplied to the container, the discharge amount of the pump is lower than the discharge amount of the pump when the undiluted soup is supplied to the container.

The operation control component in the present invention may continuously operate the pump when the undiluted soup is not supplied to the container.

Then, when the supply condition is determined by the condition determination component 343 and the container C has been conveyed to the supply position P3 (see FIG. 1), the first supply unit 21 starts to supply the undiluted soup to the container C. With this configuration, the container C being warmed in the container accommodating unit 50 (see FIG. 1) is conveyed to the supply position P3 without being cooled down. As a result, the undiluted soup supplied to the container C is kept warm by the container C.

Note that the first supply unit of the present invention may convey the container to the supply position, based on a conveying time required until the container reaches the delivery position from the supply position. In this case, the first supply unit in the present invention can convey the container to the supply position at optimal timing for delivery of the ingredient to the container and start to supply the undiluted soup to the container by, for example, calculating back the conveying time.

When the undiluted soup starts to be supplied, the operation control component 344 controls the operation of the valve 214 so as to connect the acquisition path 211 to the supply path 213. As a result, the undiluted soup is guided from the acquisition path 211 to the supply path 213. That is, the valve 214 also functions as a supply valve in the present invention. In this case, since the undiluted soup is circulating through the circulation path in advance, the undiluted soup reaches the exit of the supply path 213 and is discharged to the liquid receiver 25 earlier than a case where the undiluted soup is not circulating. That is, the supply time interval of the undiluted soup is shortened. The undiluted soup discharged to the liquid receiver 25 spirally revolves along the inner surface 25a as illustrated in FIG. 4 and FIG. 5, and is supplied to the container C to be disposed at the supply position P3. The liquid volume of the undiluted soup being supplied is measured by the flow meter 216. The operation control component 344 withdraws the shutter 247 from below the syringe 241 when starting the supply of the grated garlic to the container C, and advances the shutter 247 to below the syringe 241 when the supply of the grated garlic to the container C has stopped.

At the timing when a predetermined liquid volume of the undiluted soup has been supplied to the container C, the operation control component 344 stops the supply of the undiluted soup to the container C. When stopping the supply of the undiluted soup to the container C, the operation control component 344 stops the operation of the pump 215 so as to stop the discharge of the undiluted soup in the forward direction, and controls the operation of the valve 214 so as to connect the acquisition path 211 to the return path 212 for a predetermined time (for example, 500 msec). As a result of this connection, the undiluted soup discharged from the pump 215 when the pump 215 stops is guided to the return path 212 without flowing to the supply path 213. As a result, the liquid volume of the undiluted soup to the container C is stabilized. Since the valve 214 is switched, the undiluted soup in the supply path 213 is discharged from the exit by the gravitational force, and air is introduced from the exit into the supply path 213. In other words, the supply path 213 functions as the air introduction path in the present invention, and the valve 214 also functions as an air introduction valve in the present invention. As a result, a predetermined amount of the undiluted soup out of the undiluted soup in the supply path 213 is supplied to the container C by the gravitational force.

After the predetermined time has elapsed, the operation control component 344 controls the operation of the valve 214 so as to connect the acquisition path 211 to the supply path 213 for a predetermined time (for example, 500 msec), and controls the operation of the pump 215 such that the undiluted soup flows back from the pump 215 toward the first reserve tank T1. That is, the operation control component 344 operates the pump 215 in a reverse direction (in a direction in which the pump 215 discharges the undiluted soup toward the first reserve tank T1). As a result, the undiluted soup (residual liquid) remaining in the supply path 213 and in a portion of the acquisition path 211 downstream of the pump 215 is recovered from the pump 215 toward the first reserve tank T1.

Note that when the operation of the pump is stopped so as to stop the discharge of the undiluted soup in the forward direction, the operation control component in the present invention may operate the pump in the reverse direction without connecting the acquisition path to the return path.

After a predetermined time has elapsed, the operation control component 344 controls the operation of the valve 214 so as to connect the acquisition path 211 to the return path 212, and controls the operation of the pump 215 so as to stop the operation in the reverse direction. Then, the operation control component 344 intermittently operates the pump 215 in the forward direction as described above.

### Conclusion (1)

According to the embodiment described above, the present apparatus 1 includes the acquisition component 341, the condition determination component 343, the supply unit 20, and the operation control component 344. The supply unit 20 includes the acquisition paths 211, 221, and 231, the return paths 212, 222, and 232, the supply paths 213, 223, and 233, and the valves 214, 224, and 234. The operation control component 344 connects the acquisition paths 211, 221, and 231 to the supply paths 213, 223, and 233 when the seasoning liquids (soup: the undiluted soup, the broth, and the oil according to the order) are supplied to the container C, and connects the acquisition paths 211, 221, and 231 to the return paths 212, 222, and 232 when the seasoning liquids are not supplied to the container C. With this configuration, when the seasoning liquids are not supplied to the container C, each of the seasoning liquids (the undiluted soup, the broth, and the oil) circulates through each of the circulation paths. Therefore, the convection is generated in the seasoning liquids (the undiluted soup, the broth, and the oil) in the respective reserve tanks T1 to T3, and the seasoning liquids in the respective reserve tanks T1 to T3 are stirred. As a result, the variations in concentration and temperature of the seasoning liquids in the respective reserve tanks T1 to T3 are reduced, and the seasoning liquids are also restrained from bumping in the respective reserve tanks T1 to T3. Each of the seasoning liquids at a constant concentration and at a predetermined temperature or higher always flows in the forward direction through each of the circulation paths. As a result, the present apparatus 1 can mechanically supply the seasoning liquids having stable quality to the container C.

A user of the present apparatus 1 can easily clean the pipes (in particular, the circulation paths), for example, by reserving a cleaning liquid in the reserve tanks T1 to T3.

According to the embodiment described above, when the seasoning liquids are not supplied to the container C, the operation control component 344 intermittently operates the pumps 215, 225, and 235, and/or operates the pumps 215, 225, and 235 such that the discharge amounts of the pumps 215, 225, and 235 are lower than the discharge amounts thereof when the seasoning liquids are supplied to the container C. With this configuration, power saving can be achieved, and tubes that receive pressure by the pumps 215, 225, and 235 being the tube pumps are restrained from deteriorating. As a result, the discharge amounts of the pumps 215, 225, and 235 do not fluctuate. Accordingly, the present apparatus 1 can mechanically supply the seasoning liquids having stable quality to the container C.

According to the embodiment described above, when stopping the supply of the seasoning liquids to the container C, the operation control component 344 controls the operations of the pumps 215, 225, and 235 so as to stop the discharge of the seasoning liquids toward the supply paths 213, 223, and 233, and controls the valves 214, 224, and 234 so as to connect the acquisition paths 211, 221, and 231 to the return paths 212, 222, and 232. With this configuration, the undiluted soup discharged from the pumps 215, 225, and 235 when the pumps 215, 225, and 235 are stopped are guided to the return paths 212, 222, and 232 without flowing to the supply paths 213, 223, and 233. As a result, the liquid volume of the undiluted soup to the container C is stabilized.

According to the embodiment described above, when stopping the supply of the seasoning liquids to the container C, the operation control component 344 controls the operations of the pumps 215, 225, and 235 such that the seasoning liquids flow in the reverse direction from the pumps 215, 225, and 235 toward the respective reserve tanks T1 to T3. With this configuration, the residual liquids in the supply paths 213, 223, and 233 and in the portions of the acquisition paths 211, 221, and 231 downstream of the pumps 215, 225, and 235 are recovered toward the pumps 215, 225, and 235. As a result, excess residual liquids are not generated in the present apparatus 1. Accordingly, the present apparatus 1 can mechanically supply the seasoning liquids having stable quality to the container C.

According to the embodiment described above, each of the supply paths 213, 223, and 233 functions as the air introduction path in the present invention. Each of the valves 214, 224, and 234 functions as the loop valve, the supply valve, and the air introduction valve in the present invention. That is, each of the supply paths 213, 223, and 233 is common to the air introduction path, and each of the supply valves is common to the loop valve and the air introduction valve. With this configuration, the numbers of pipes, joints, and valves constituting the supply unit 20 are reduced. As a result, the maintainability of the supply unit 20 is improved. Accordingly, the present apparatus 1 can mechanically supply the seasoning liquids having stable quality to the container C.

According to the embodiment described above, the supply unit 20 includes the liquid receiver 25 disposed between the exits of the supply paths 213, 223, and 233 and the container C. The liquid receiver 25 has the mortar-shaped inner surface 25a. With this configuration, even when the flow velocity of the seasoning liquid from each of the first supply unit 21, the second supply unit 22, and the third supply unit 23 is increased, the flow velocity is reduced at the liquid receiver 25. As a result, when the seasoning liquids are supplied to the container C, the seasoning liquids are restrained from bubbling, and the seasoning liquids are prevented from spilling from the container C. Accordingly, the present apparatus 1 can mechanically supply the seasoning liquids having stable quality to the container C.

The exits of the supply paths 213, 223, and 233 are disposed along the tangential directions of the inner surface 25a in the top view. With this configuration, at the liquid receiver 25, the seasoning liquids spirally revolve on the inner surface 25a. As a result, the flow velocities of the seasoning liquids are effectively reduced at the liquid receiver 25.

According to the embodiment described above, the viscous body supply unit 24 includes the shutter 247 that restricts the supply of the grated garlic from the syringe 241 to the container C. The shutter 247 withdraws from below the syringe 241 when the supply of the grated garlic to the container C starts, and advances to below the syringe 241 when the supply of the grated garlic to the container C has stopped. With this configuration, the grated garlic that can be left at the exit of the syringe 241 by viscosity of itself is prevented from unexpectedly dropping to the container C. As a result, the present apparatus 1 can mechanically supply the seasoning liquids having stable quality to the container C.

According to the embodiment described above, the present apparatus 1 includes the first supply unit 21, the second supply unit 22, and the third supply unit 23 corresponding to the respective seasoning liquids. With this configuration, when the supply of the seasoning liquids to the container C is stopped, the present apparatus 1 can circulate each of seasoning liquids through each of the circulation paths. As a result, the present apparatus 1 can mechanically supply the seasoning liquids having stable quality to the container C.

According to the embodiment described above, the first supply unit 21 and the second supply unit 22 corresponding to the undiluted soup and the broth, respectively, serving as a first seasoning liquid are separate from the third supply unit 23 corresponding to the oil serving as a second seasoning liquid. With this configuration, the first seasoning liquid is not mixed with the second seasoning liquid in the supply unit 20. Accordingly, the present apparatus 1 can mechanically supply the seasoning liquids having stable quality to the container C.

According to the embodiment described above, the supply unit 20 starts the supply of the seasoning liquids to the container C, based on the conveying time. With this configuration, the supply unit 20 can start the supply of the undiluted soup to the container C at optimal timing for delivery of the ingredient to the container C by calculating back the conveying time.

According to the embodiment described above, the present apparatus 1 includes the container accommodating unit 50 that keeps the plurality of containers C warm at the predetermined temperature. When the container C has been conveyed to the supply position P3, the supply unit 20 starts to supply the seasoning liquids to the container C. With this configuration, the container C being warmed in the container accommodating unit 50 is conveyed to the supply position P3 without being cooled down. As a result, the seasoning liquids supplied to the container C is kept warm by the container C. That is, the quality (temperature) of the seasoning liquids supplied to the container C is stabilized.

According to the embodiment described above, each of the acquisition paths 211, 221, and 231, the return paths 212, 222, and 232, and the supply paths 213, 223, and 233 is fitted in each of the corresponding supporting units 131 in such a way as to be detachable by a human hand. As a result, the maintainability of the constituent pipes, joints, and valves is improved. Accordingly, the present apparatus 1 can mechanically supply the seasoning liquids having stable quality to the container C.

Note that each of the valves in the present invention may be constituted of a single three-way valve.

### Cooking Apparatus (2)

Another embodiment (second embodiment) of the present apparatus will now be described focusing on differences from the embodiment (first embodiment) described above. A cooking apparatus in the second embodiment differs from the cooking apparatus in the first embodiment in configuration and operation of the supply unit.

### Configuration of Cooking Apparatus (2)

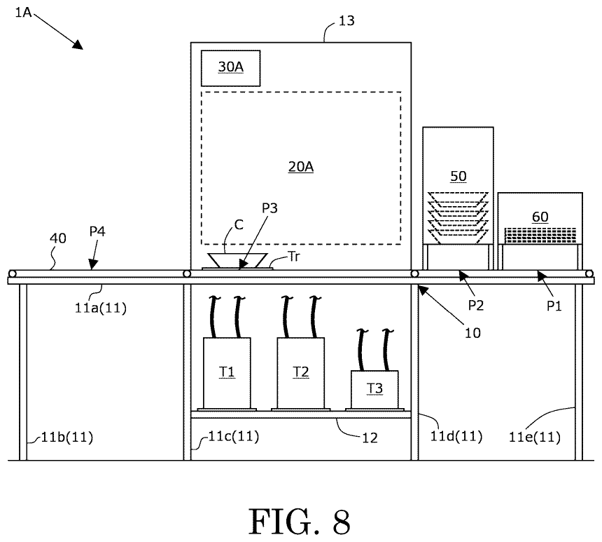

FIG. 8 is a schematic configuration diagram illustrating the another embodiment of the present apparatus.

A present apparatus 1A includes the housing 10, a supply unit 20A, a control device 30A, the conveying unit 40, the container accommodating unit 50, and the tray accommodating unit 60.

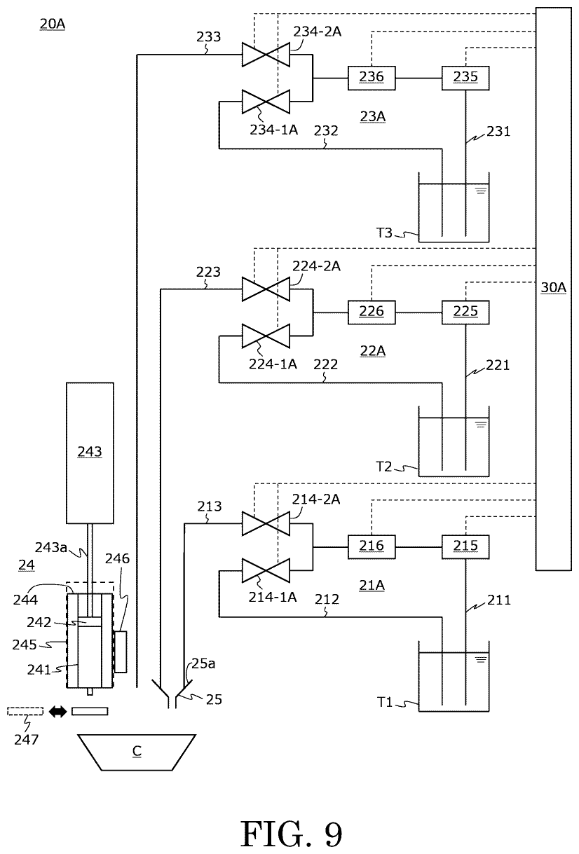

FIG. 9 is a piping diagram of the supply unit 20A.

For convenience of description, FIG. 9 also illustrates the control device 30A and wiring between the supply unit 20A and the control device 30A.

The supply unit 20A supplies a predetermined liquid volume of the seasoning liquids to the container C. The supply unit 20A includes a first supply unit 21A, a second supply unit 22A, a third supply unit 23A, the viscous body supply unit 24, and the liquid receiver 25.

The first supply unit 21A supplies the undiluted soup reserved in the first reserve tank T1 to the container C. The first supply unit 21A includes the acquisition path 211, the return path 212, the supply path 213, a first valve 214-1A, a second valve 214-2A, the pump 215, and the flow meter 216. The first supply unit 21A in the present embodiment differs from the first supply unit 21 in the first embodiment in that the valve 214 in the first embodiment is constituted of the two valves (the first valve 214-1A and the second valve 214-2A).

An end on a downstream side of the acquisition path 211 branches into two lines, which are connected to the first valve 214-1A and the second valve 214-2A.

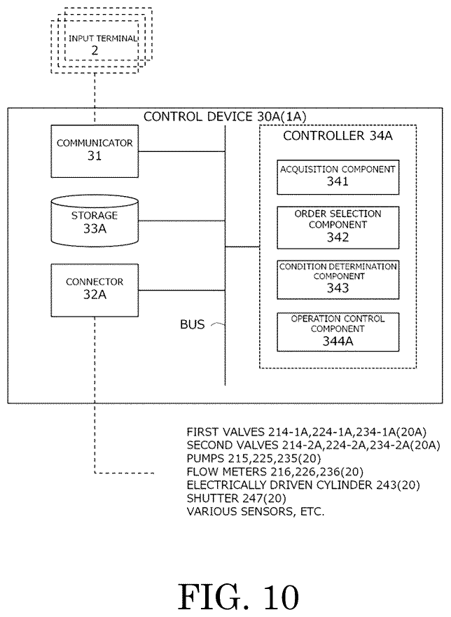

The first valve 214-1A is disposed between the acquisition path 211 and the return path 212. The first valve 214-1A is opened to connect the acquisition path 211 to the return path 212, and is closed to disconnect the acquisition path 211 from the return path 212. The first valve 214-1A constitutes a portion of the connection switch unit in the present invention. The first valve 214-1A is, for example, a pinch valve that does not make wet contact. The operation of the first valve 214-1A is electrically controlled by a below-described operation control component 344A (see FIG. 10; the same applies below).

The second valve 214-2A is disposed between the acquisition path 211 and the supply path 213. The second valve 214-2A is opened to connect the acquisition path 211 to the supply path 213, and is closed to disconnect the acquisition path 211 from the supply path 213. The second valve 214-2A constitutes a portion of the connection switch unit in the present invention. The second valve 214-2A is, for example, a pinch valve. The operation of the second valve 214-2A is electrically controlled by the below-described operation control component 344A.

The second supply unit 22A supplies the broth reserved in the second reserve tank T2 to the container C. The second supply unit 22A includes the acquisition path 221, the return path 222, the supply path 223, a first valve 224-1A, a second valve 224-2A, the pump 225, and the flow meter 226. The second supply unit 22A in the present embodiment differs from the second supply unit 22 in the first embodiment in that the valve 224 in the first embodiment is constituted of the two valves (the first valve 224-1A and the second valve 224-2A).

An end on a downstream side of the acquisition path 221 branches into two lines, which are connected to the first valve 224-1A and the second valve 224-2A.

The first valve 224-1A is disposed between the acquisition path 221 and the return path 222. The first valve 224-1A is opened to connect the acquisition path 221 to the return path 222, and is closed to disconnect the acquisition path 221 from the return path 222. The first valve 224-1A constitutes a portion of the connection switch unit in the present invention. The first valve 224-1A is, for example, a pinch valve. The operation of the first valve 224-1A is electrically controlled by the below-described operation control component 344A.

The second valve 224-2A is disposed between the acquisition path 221 and the supply path 223. The second valve 224-2A is opened to connect the acquisition path 221 to the supply path 223, and is closed to disconnect the acquisition path 221 from the supply path 223. The second valve 224-2A constitutes a portion of the connection switch unit in the present invention. The second valve 224-2A is, for example, a pinch valve. The operation of the second valve 224-2A is electrically controlled by the below-described operation control component 344A.

The third supply unit 23A supplies the oil reserved in the third reserve tank T3 to the container C. The third supply unit 23A includes the acquisition path 231, the return path 232, the supply path 233, a first valve 234-1A, a second valve 234-2A, the pump 235, and the flow meter 236. The third supply unit 23A in the present embodiment differs from the third supply unit 23 in the first embodiment in that the valve 234 in the first embodiment is constituted of the two valves (the first valve 234-1A and the second valve 234-2A).

An end on a downstream side of the acquisition path 231 branches into two lines, which are connected to the first valve 234-1A and the second valve 234-2A.

The first valve 234-1A is disposed between the acquisition path 231 and the return path 232. The first valve 234-1A is opened to connect the acquisition path 231 to the return path 232, and is closed to disconnect the acquisition path 231 from the return path 232. The first valve 234-1A constitutes a portion of the connection switch unit in the present invention. The first valve 234-1A is, for example, a pinch valve. The operation of the first valve 234-1A is electrically controlled by the below-described operation control component 344A.

The second valve 234-2A is disposed between the acquisition path 231 and the supply path 233. The second valve 234-2A is opened to connect the acquisition path 231 to the supply path 233, and is closed to disconnect the acquisition path 231 from the supply path 233. The second valve 234-2A constitutes a portion of the connection switch unit in the present invention. The second valve 234-2A is, for example, a pinch valve. The operation of the second valve 234-2A is electrically controlled by the below-described operation control component 344A.

In the present embodiment, each of the first valves 214-1A, 224-1A, and 234-1A, and the second valves 214-2A, 224-2A, and 234-2A has one flow channel (path).

FIG. 10 is a functional block diagram of the present apparatus 1A.

The control device 30A controls the overall operation of the present apparatus 1A. The control device 30A includes the communicator 31, a connector 32A, a storage 33A, and a controller 34A. The control device 30A is, for example, a personal computer.

The connector 32A is an interface connected to, for example, the first valves 214-1A, 224-1A, and 234-1A, the second valves 214-2A, 224-2A, and 234-2A, the pumps 215, 225, and 235, the flow meters 216, 226, 236, the electrically driven cylinder 243, the driving unit of the shutter 247, and below-described sensors.

The storage 33A stores information required for the operation of the present apparatus 1A. The storage 33A is constituted of, for example, a recording device such as an HDD or an SSD and/or a semiconductor memory device such as a RAM or a flash memory.

The controller 34A controls the overall operation of the present apparatus 1A. The controller 34A is constituted of, for example, a processor such as a CPU or a DSP and a semiconductor memory such as a RAM or a ROM. The controller 34A includes the acquisition component 341, the order selection component 342, the condition determination component 343, and the operation control component 344A.

The operation control component 344A controls the operation of the supply unit 20A. The operation of the operation control component 344A will be described below.

### Operation of Operation Control Component (2)

The operation of the operation control component 344A will now be described below with reference to also FIG. 9 and FIG. 10. In the present embodiment, the operations of the first supply unit 21A, the second supply unit 22A, and the third supply unit 23A are common to one another. Therefore, the operation of the operation control component 344A will be described below using the operation of the first supply unit 21A as an example. The operation of the operation control component 344A is common to the operation of the operation control component 344 of the first embodiment except that details of the control of the connection switch unit differ from those of the first embodiment. Therefore, the present apparatus 1A provides an advantageous effect similar to that of the present apparatus 1 of the first embodiment.

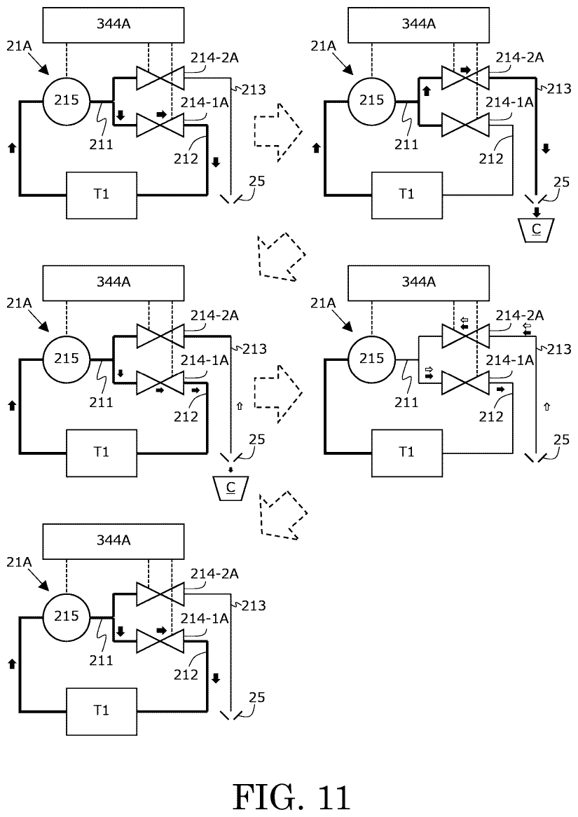

FIG. 11 is an explanatory diagram illustrating an example of the operation of the operation control component 344A in chronological order.

First, when the undiluted soup (that is, the soup) is not supplied to the container C, the operation control component 344A opens the first valve 214-1A to connect the acquisition path 211 to the return path 212, and closes the second valve 214-2A to disconnect the acquisition path 211 from the supply path 213. In this case, the operation control component 344A intermittently operates the pump 215 in the forward direction at intervals of a predetermined time. As a result, the undiluted soup circulates to the first reserve tank T1 through the acquisition path 211 and the return path 212 (circulation path). That is, the first valve 214-1A functions as a loop valve in the present invention.

Then, when a supply condition is determined by the condition determination component 343 and the container C has been conveyed to the supply position P3, the first supply unit 21A starts to supply the undiluted soup to the container C.

When the undiluted soup starts to be supplied, the operation control component 344A controls the operation of the connection switch unit (the first valve 214-1A and the second valve 214-2A) so as to connect the acquisition path 211 to the supply path 213. That is, the operation control component 344A closes the first valve 214-1A to disconnect the acquisition path 211 from the return path 212, and opens the second valve 214-2A to connect the acquisition path 211 to the supply path 213. As a result, the undiluted soup is guided from the acquisition path 211 to the supply path 213. That is, the second valve 214-2A functions as the supply valve in the present invention. The undiluted soup discharged to the liquid receiver 25 spirally revolves along the inner surface 25a (see FIG. 4), and is supplied to the container C to be disposed at the supply position P3. The liquid volume of the undiluted soup being supplied is measured by the flow meter 216.

At the time when a predetermined liquid volume of the undiluted soup has been supplied to the container C, the operation control component 344A stops the supply of the undiluted soup to the container C. When stopping the supply of the undiluted soup to the container C, the operation control component 344A stops the operation of the pump 215 so as to stop the discharge of the undiluted soup in the forward direction, and controls the operation of the connection switch unit so as to connect the acquisition path 211 to the return path 212 for a predetermined time (for example, 500 msec). That is, the operation control component 344A closes the second valve 214-2A to disconnect the acquisition path 211 from the supply path 213, and opens the first valve 214-1A to connect the acquisition path 211 to the return path 212. This predetermined time is an example of a first time in the present invention. As a result of this connection, the undiluted soup discharged from the pump 215 when the pump 215 stops is guided to the return path 212 without flowing to the supply path 213. As a result, the liquid volume of the undiluted soup to the container C is stabilized. Since the second valve 214-2A is closed, the undiluted soup in the supply path 213 is discharged from the exit by the gravitational force, and air is introduced from the exit into the supply path 213. In other words, the supply path 213 functions as the air introduction path in the present invention, and the second valve 214-2A also functions as the air introduction valve in the present invention.

After the predetermined time (first time) has elapsed, the operation control component 344A controls the operation of the connection switch unit so as to connect the return path 212 to the supply path 213 for a predetermined time (for example, 500 msec). That is, the operation control component 344A opens the second valve 214-2A to connect the acquisition path 211 and the return path 212 to the supply path 213. This predetermined time is an example of a second time in the present invention. As a result, the undiluted soup (residual liquid) remaining in the supply path 213 and in a portion of the acquisition path 211 downstream of the pump 215 is recovered by the gravitational force to the first reserve tank T1 through the return path 212.

After the predetermined time (second time) has elapsed, the operation control component 344A controls the operation of the connection switch unit to connect the acquisition path 211 to the return path 212. That is, the operation control component 344A closes the second valve 214-2A to disconnect the acquisition path 211 and the return path 212 from the supply path 213. Then, the operation control component 344A intermittently operates the pump 215 in the forward direction as described above.

Note that the operation control component in the present invention may operate the pump such that, when the undiluted soup is not supplied to the container, the discharge amount of the pump is lower than the discharge amount of the pump when the undiluted soup is supplied to the container.

The operation control component in the present invention may continuously operate the pump when the undiluted soup is not supplied to the container.

### Conclusion (2)

According to the embodiment described above, when the seasoning liquids are not supplied to the container C, each of the seasoning liquids (the undiluted soup, the broth, and the oil) circulates through each of the circulation paths in the same manner as in the first embodiment. Therefore, the convection is generated in the seasoning liquids (the undiluted soup, the broth, and the oil) in the respective reserve tanks T1 to T3, and the seasoning liquids in the respective reserve tanks T1 to T3 are stirred. As a result, the variations in concentration and temperature of the seasoning liquids in the respective reserve tanks T1 to T3 are reduced, and the seasoning liquids are also restrained from bumping in the respective reserve tanks T1 to T3. Each of the seasoning liquids at a constant concentration and at a predetermined temperature or higher always flows in the forward direction through each of the circulation paths. As a result, the present apparatus 1A can mechanically supply the seasoning liquids having stable quality to the container C.

Note that each of the first supply unit, the second supply unit, and the third supply unit in the present invention may include the air introduction path connected to the supply path. In this case, the air introduction path includes the air introduction valve that introduces air into the supply path.

### Conclusion (Other)

The type of each of the first seasoning liquid and the second seasoning liquid included in the seasoning liquid is not limit to that of the embodiments. That is, for example, the seasoning liquid may include only one type of the first seasoning liquid, or may include three or more types of the first seasoning liquids and two or more types of the second seasoning liquids.

The supply units (the first supply unit and the second supply unit) corresponding to the first seasoning liquid (the undiluted soup and the broth) in the present invention need not be separate. That is, for example, a portion of the first supply unit in the present invention may be common to a portion of the second supply unit in the present invention. Specifically, for example, the supply path in the present invention may be common to the first supply unit and the second supply unit.

The seasoning in the present invention is not limited to the grated garlic. That is, for example, the seasoning in the present invention may be secret sauce, grated ginger, or grated daikon radish.

Each of the valves in the present invention only needs to be electrically controlled, and is not limited to the pinch valve. That is, for example, the valve in the present invention may be a solenoid valve of a type in which a mechanical unit makes wet contact.

The pump in the present invention is not limited to the tube pump. That is, for example, the pump in the present invention may be a pump of a type in which a liquid feeding portion other than the flow channel (path) makes wet contact.

The flow meter in the present invention is not limited to the clamp-on ultrasonic flow meter. That is, for example, the flow meter in the present invention may be a Coriolis flow meter, or may be a flow meter of a type (such as an electromagnetic type) in which a portion other than the flow channel (path) makes wet contact.

A part or all of the paths in the present invention need not be cover with the pipe thermal insulating material.

The present apparatus need not include the viscous body supply unit, the liquid receiver, the container accommodating unit, and/or the tray accommodating unit.

The bridge member in the present invention is not limited to the hook-and-loop fastener tape. That is, for example, the bridge member in the present invention may be a plate-like (rod-like) member rotatably attached to one of the pinching members. In this case, for example, a distal end of the member is attached in a bridging manner to the pinching members by being locked to an L-shaped projection provided on the other of the pinching members.

The order selection component in the present invention may acquire, for each order, a noodle boiling time required for hardness of the noodle corresponding to the order, and may select the order information, based on the noodle boiling time. In this case, the configuration is made such that the noodle is finished to one hardness level among a plurality of hardness levels with different noodle boiling times required to finish the noodle. The noodle boiling times corresponding to the hardness levels of the noodle are, for example, stored in advance in the storage. The noodle boiling time is an example of a finishing time in the present invention, and is an example of information included in order-related information in the present invention. The “order-related information” is, information related to an order such as information related to the food and drink product (the ingredient and the seasoning liquid) prepared in response to the order and information related to an orderer (guest), and is, for example, information to be acquired from outside the present apparatus. In addition, the supply unit may start the supply of the seasoning liquid to the container, based on a supply condition (liquid volume) and the noodle boiling time (finishing time). With this configuration, the present apparatus can supply soup according to the noodle boiling time. As a result, the present apparatus contributes to efficient serving of the food and drink product (ramen).

The order selection component in the present invention may acquire ingredient information, and may select the order information, based on the ingredient information. The “ingredient information” is information indicating whether the noodle is present in each of a plurality of regions (finishing regions) where noodle boiling baskets are put in a cooking utensil (stockpot) required for finishing (boiling) the noodle. The ingredient information is an example of information included in the order-related information in the present invention. With this configuration, the present apparatus can supply the soup according to a state of availability of the regions for boiling the noodle. As a result, the present apparatus contributes to the efficient serving of the food and drink product (ramen). The ingredient information is transmitted to the order selection component, for example, through input from a sensor that detects whether the noodle (basket) is present in the finishing regions, or through an input operation by a user of the present apparatus.

The order selection component in the present invention may acquire the number-of-people information indicating the number of guests entering an eating and drinking establishment, and may select the order information, based on the number-of-people information. The number-of-people information is an example of information included in the order-related information in the present invention. In this case, the order selection component acquires the number of people, for example, based on input information (including information while being entered) from an input terminal to which the guest is making input. With this configuration, the present apparatus can predict the number of orders to be made within a predetermined time, and can supply the soup, based on the prediction. The present apparatus can predict the ingredient information (transition of the availability of the finishing regions), based on the number-of-people information, and can supply the soup, based on the prediction. As a result, the present apparatus contributes to the efficient serving of the food and drink product (ramen). The number-of-people information is transmitted to the order selection component, for example, through input from a sensor that detects entrance to the establishment, the input from the input operation terminal, or the input operation by a user of the present apparatus.

When a reorder is included in the order, the order selection component in the present invention may preferentially select the order information corresponding to the reorder. The order information corresponding to the reorder is an example of information included in the order-related information in the present invention. The “reorder” is an order indicating redoing of the supply of the seasoning liquid to the container. With this configuration, the present apparatus can supply the soup so as not to delay the serving of the food and drink product (ramen) to a guest. As a result, the present apparatus contributes to the efficient serving of the food and drink product (ramen). The order information corresponding to the reorder is transmitted to the order selection component, for example, through alarm information on the present apparatus or the input operation by a user of the present apparatus.

The order selection component in the present invention may acquire remaining amount information indicating the remaining amount of the seasoning liquid reserved in each of the reserve tanks, and may select the order information, based on the remaining amount information. The remaining amount information is an example of information included in the order-related information in the present invention. With this configuration, the present apparatus can efficiently use up each of the seasoning liquids, and a user of the present apparatus can efficiently replace each of the seasoning liquids. As a result, the present apparatus contributes to the efficient serving of the food and drink product (ramen). The remaining amount information is transmitted to the order selection component, for example, through input from a sensor that detects the liquid volume in each of the reserve tanks, or through the input operation by a user of the present apparatus.

The order selection component in the present invention may select the order information, based on two or more pieces of information among the finishing information, the ingredient information, the number-of-people information, the order information corresponding to the reorder, and the remaining amount information.

The acquisition component in the present invention may acquire the order information, based on an order written on a paper order form. In this case, for example, a user of the present apparatus enters a content of the order using a non-illustrated device for input (including manual input and voice input).

### REFERENCE SIGNS LIST

1 Cooking apparatus
131 Supporting unit
131a Pinching member
131b Pinching member
131c Bridge member
20 Supply unit
21 First supply unit
211 Acquisition path
212 Return path
213 Supply path (air introduction path)
214 Valve (connection switch unit, loop valve, supply valve, air introduction valve)
215 Pump
22 Second supply unit
221 Acquisition path
222 Return path
223 Supply path (air introduction path)
224 Valve (connection switch unit, loop valve, supply valve, air introduction valve)
225 Pump
23 Third supply unit
231 Acquisition path
232 Return path
233 Supply path (air introduction path)
234 Valve (connection switch unit, loop valve, supply valve, air introduction valve)
235 Pump
24 Viscous body supply unit
241 Syringe
244 Holder
245 Case
246 Temperature adjusting unit
247 Shutter
25 Liquid receiver
25a Inner surface
341 Acquisition component
342 Order selection component
343 Condition determination component
344 Operation control component
40 Conveying unit
50 Container accommodating unit
1A Cooking apparatus
20A Supply unit
21A First supply unit
214-1A First valve (connection switch unit, loop valve)
214-2A Second valve (connection switch unit, supply valve, air introduction valve)
22A Second supply unit
224-1A First valve (connection switch unit, loop valve)
224-2A Second valve (connection switch unit, supply valve, air introduction valve)
23A Third supply unit
234-1A First valve (connection switch unit, loop valve)
234-2A Second valve (connection switch unit, supply valve, air introduction valve)
C Container
T1 First reserve tank
T2 Second reserve tank
T3 Third reserve tank

1. A cooking apparatus to supply a seasoning liquid to be included in a food and drink product to a container, the cooking apparatus comprising:
an acquisition component configured to acquire order information indicating a content of each order for the food and drink product;
a condition determination component configured to determine a supply condition of the seasoning liquid, based on the order information;
a supply unit configured to supply a predetermined liquid volume of the seasoning liquid to the container, based on the supply condition; and
an operation control component configured to control operation of the supply unit, wherein
the supply unit includes:
an acquisition path configured to acquire the seasoning liquid from a reserve tank that reserves the seasoning liquid;
a return path configured to return the seasoning liquid from the acquisition path to the reserve tank;
a supply path configured to supply the seasoning liquid from the acquisition path to the container;
a connection switch unit configured to switch connection among the acquisition path, the return path, and the supply path by being controlled by the operation control component; and
a pump attached to the acquisition path and configured to discharge the seasoning liquid, and
the operation control component controls, when the seasoning liquid is supplied to the container, operation of the connection switch unit so as to connect the acquisition path to the supply path, and controls, when the seasoning liquid is not supplied to the container, the operation of the connection switch unit so as to connect the acquisition path to the return path,
and intermittently operates the pump and/or controls operation of the pump such that a discharge amount of the pump is lower than the discharge amount of the pump when the seasoning liquid is supplied to the container.

2. (canceled)

3. The cooking apparatus according to claim 1, wherein, when stopping the supply of the seasoning liquid to the container, the operation control component controls the operation of the pump so as to stop the discharge of the seasoning liquid toward the supply path, and controls the connection switch unit so as to connect the acquisition path to the return path.

4. The cooking apparatus according to claim 3, wherein, when stopping the supply of the seasoning liquid to the container, the operation control component controls the operation of the pump such that the seasoning liquid flows back from the pump toward the reserve tank.

5. The cooking apparatus according to claim 3, wherein
the supply unit includes an air introduction path configured to introduce air into the supply path,
the connection switch unit includes:
a loop valve connected to the return path and configured to introduce the seasoning liquid into the return path;
a supply valve connected to the supply path and configured to introduce the seasoning liquid into the supply path; and
an air introduction valve connected to the air introduction path and configured to introduce the air into the supply path, and
the supply valve is common to the air introduction valve, or to the loop valve and the air introduction valve.

6. The cooking apparatus according to claim 3, wherein the operation control component controls the connection switch unit so as to connect the return path to the supply path within a first time from when the acquisition path is connected to the return path, and controls the connection switch unit so as to connect the acquisition path to the return path within a second time from when the first time elapses.

7. The cooking apparatus according to claim 6, wherein
the supply unit includes an air introduction path configured to introduce air into the supply path,
the connection switch unit includes:
a loop valve connected to the return path and configured to introduce the seasoning liquid into the return path;
a supply valve connected to the supply path and configured to introduce the seasoning liquid into the supply path; and
an air introduction valve connected to the air introduction path and configured to introduce the air into the supply path, and
the operation control component controls the connection switch unit so as to open the loop valve, the supply valve, and the air introduction valve within the first time and close the supply valve and the air introduction valve within the second time from when the first time elapses.

8. The cooking apparatus according to claim 1, wherein the supply unit includes a liquid receiver configured to be disposed between an exit on the container side of the supply path and the container and has a mortar-shaped inner surface.

9. The cooking apparatus according to claim 8, wherein the exit is disposed along a tangential direction of the inner surface of the liquid receiver in a top view.

10. The cooking apparatus according to claim 1, further comprising a viscous body supply unit configured to supply a viscous body-like seasoning having higher viscosity than viscosity of the seasoning liquid to the container, wherein
the viscous body supply unit includes:
a syringe to be filled with the seasoning;
a holder configured to hold the syringe in a detachable manner; and
a shutter configured to restrict the seasoning from being supplied from the syringe to the container, and
the shutter withdraws from below the syringe when the seasoning starts to be supplied to the container, and advances to below the syringe when the seasoning stops being supplied to the container.

11. The cooking apparatus according to claim 10, wherein
the viscous body supply unit includes:
a case that accommodates the syringe; and
a temperature adjusting unit configured to adjust temperature of the seasoning filled in the syringe to a predetermined temperature in the case, and
the temperature adjusting unit abuts on the holder or the case.

12. The cooking apparatus according to claim 1, wherein
the food and drink product includes a plurality of types of the seasoning liquids, and
the cooking apparatus includes the supply unit corresponding to each of the plurality of types of the seasoning liquids.

13. The cooking apparatus according to claim 12,
wherein
the plurality of types of the seasoning liquids include:
a specific seasoning liquid to be supplied in response to all orders; and
a non-specific seasoning liquid to be supplied in response to some of the orders, and
the supply unit corresponding to the specific seasoning liquid is separate from the supply unit corresponding to the non-specific seasoning liquid.

14. The cooking apparatus according to claim 1, further comprising an order selection component that selects a piece of the order information from among a plurality of pieces of the order information, when the acquisition component acquires the plurality of pieces of the order information corresponding to a plurality of the orders, the selected order information being used by the condition determination component to determine the supply condition, wherein
the order selection component selects the piece of the order information, based on time information included in the order information.

15. The cooking apparatus according to claim 14,
wherein
the order selection component is configured to:
acquire order-related information related to the order; and
select the piece of the order information, based on the order-related information.

16. The cooking apparatus according to claim 15, wherein
the cooking apparatus is disposed in an eating and drinking establishment that serves the food and drink product to a customer,
the food and drink product includes an ingredient to be dipped in the seasoning liquid,
a cooking utensil required for finishing the ingredient has a plurality of finishing regions to finish the ingredient,
the ingredient is finished to one of a plurality of finished states with different finishing times required to finish the ingredient for each order, and
the order-related information includes at least one of:
finishing time information indicating the finishing time corresponding to the order;
ingredient information indicating whether the ingredient is present in each of the plurality of finishing regions;
number-of-people information indicating number of the customers entering the eating and drinking establishment;
the order information corresponding to a reorder indicating redoing of the supply of the seasoning liquid to the container; and
remaining amount information indicating a remaining amount of the seasoning liquid reserved in the reserve tank.

17. The cooking apparatus according to claim 16, wherein
the customer operates an input terminal for entering a content of the order, and
the order selection component is configured to acquire the number of the customers, based on input information from the input terminal.

18. The cooking apparatus according to claim 1, wherein
the food and drink product includes an ingredient to be dipped in the seasoning liquid,
the ingredient is finished to one of a plurality of finished states with different finishing times required to finish the ingredient for each order, and
the supply unit is configured to start to supply the seasoning liquid to the container, based on the predetermined liquid volume and the finishing time.

19. The cooking apparatus according to claim 18, further comprising
a conveying unit configured to convey the container, wherein
the container is kept warm at a predetermined temperature before being conveyed by the conveying unit,
the conveying unit is configured to:
convey the container from a receiving position in which the container kept warm is received to a supply position in which the seasoning liquid is supplied to the container; and
convey the container from the supply position to a delivery position in which the ingredient finished to the one of the finished states is delivered into the container,
the supply unit starts to supply the seasoning liquid to the container when the container is conveyed to the supply position, and
the conveying unit is configured to convey the container to the supply position, based on a conveying time required until the container reaches the delivery position.

20. The cooking apparatus according to claim 1, further comprising
a plurality of supporting units configured to support the supply unit,
wherein
each of the acquisition path, the return path, and the supply path is fitted in a corresponding supporting unit in such a way as to be detachable by a human hand.

21. The cooking apparatus according to claim 20, wherein
at least one of the plurality of supporting units includes:
two pinching members disposed so as to pinch a part of a corresponding path among the acquisition path, the return path, and the supply path; and
a bridge member configured to be attached in a bridging manner between the two pinching members so as to cover the corresponding path.
